(19) United States
(12) Patent Application Publication
(10) Pub. No.: US 2022/0287359 A1
(43) Pub. Date: Sep. 15, 2022

(54) SMOKING DEVICE COMPRISING AT LEAST ONE BREAKABLE FLAVOURING CAPSULE

(71) Applicant: BIO-ON S.P.A., San Giorgio Di Piano (IT)

(72) Inventors: Paolo SAETTONE, San Giorgio Di Piano (IT); Ilaria MONACO, San Giorgio Di Piano (IT); Mauro COMES FRANCHINI, San Giorgio Di Piano (IT)

(21) Appl. No.: 17/632,439

(22) PCT Filed: Aug. 3, 2020
(86) PCT No.: PCT/IB2020/057319

§ 371 Date: Feb. 2, 2022

(30) Foreign Application Priority Data
Aug. 2, 2019 (IT) 102019000013866

(51) Int. Cl. A24D 3/06; B29C 48/16; B29C 48/00

(52) U.S. Cl. CPC A24D 3/061; A24D 3/066; B29C 48/16; B29C 48/022; B29K 2005/00

(57) ABSTRACT

A smoking device including a tubular element containing tobacco and a filtering element connected to an end of the tubular element. The filtering element includes at least one breakable flavouring capsule which includes at least one core having at least one lipophilic substance and at least one flavouring agent dispersed or dissolved in the lipophilic substance; at least one breakable coating which coats the core and which has at least one chitosan having a weight average molecular weight (Mw) between 25 kDa and 400 kDa. Preferably, the breakable coating further includes at least one polyhydroxyalkanoate (PHA). The frangible coating that coats the core is able to preserve its hardness, and therefore its breakability, during use by the smoker, i.e. in the presence of humidity and heat that develop from the combustion of tobacco.

### TECHNICAL FIELD

The present disclosure relates to a smoking device comprising at least one breakable flavouring capsule. In particular, the present disclosure concerns a smoking device comprising at least one breakable flavouring capsule which comprises a core comprising a lipophilic substance and a flavouring agent, coated with a breakable coating. The present disclosure also concerns the capsule as defined above, the use thereof for flavouring the smoke produced by a smoking device and the process for producing said capsule.

### BACKGROUND

It is well known that the sensory properties of the smoke produced by a smoking device, in particular a cigarette, can be modified by adding additives to the tobacco and/or by incorporating flavouring substances inside the different components that make up the smoking device. A method for modifying the sensory properties of the smoke produced by the smoking devices provides for the use of flavouring agents inserted inside the filtering element that is commonly present in the device itself.

For example, US patent application 2002/166563 describes a cigarette which comprises a tobacco bar and a multi-component filter that includes an element formed by activated carbon particles, which are able to absorb unwanted smoke products and to release flavours they are impregnated with.

Another method for modifying the sensory properties of the smoke produced by a smoking device consists in inserting one or more breakable capsules inside the filtering element. These capsules usually contain flavouring substances which are released inside the filtering element following the pressure exerted by the user on the filter itself, which causes the same capsules to break. It is important that the breakages of the capsules generates a sound that can be heard by the user, so as to warn him that the pressure exerted was sufficient to break the capsules and therefore to release the flavour. Flavouring allows the user to inhale smoke with modified sensory properties, such as for example a menthol-flavoured smoke.

According to WO 2006/136197, the capsules consist of a core, which includes the flavour, and a shell which encloses the core. The shell consists of at least one hydrocolloid selected from gellan gum, agar, carrageenan, pullulan gum or modified starch, optionally mixed with gelatin. The capsules are preferably coated with a layer having a humidity barrier function, in particular a hydrophobic agent, in order to avoid softening of the material which constitutes the shell when subjected to heat and humidity during the use of the cigarette. The capsules, becoming softer and more flexible, in fact lose the capability of breaking following the pressure exerted by the user on the filtering element, thus making the release of the flavouring substance enclosed in the capsule and therefore the flavouring of the smoke produced difficult, if not impossible.

In U.S. Pat. 8,470,215 flavouring and breakable capsules analogous to WO 2006/136197 are described, in which the shell is formed by a material which is able to gel when put in contact with multivalent ions. In particular, this material is a filmable material of non-animal origin, selected from alginates, starch, modified starch, pectin. Alginate, which gels when put in contact with divalent ions, in particular calcium ions, is particularly preferred. Gelled alginate is more thermally stable than animal gelatin, and maintains a crushing resistance equal to at least 250 g after being exposed for at least 5 min to an atmosphere having a relative humidity equal to about 90%.

The Applicant has posed the problem of making a breakable flavouring capsule, particularly suitable for insertion into a smoking device, which comprises a core containing a flavouring agent and a breakable coating which coats said core, in which said coating has the mechanical characteristics suitable for the purpose, which are maintained over time. In particular, the coating is able to preserve its hardness, and therefore its frangibility, during use by the smoker, that is in the presence of humidity and heat that develop from the combustion of tobacco.

In this regard, the solution indicated in U.S. patent application Ser. No. 8,470,215 appears unsatisfactory, since the gelling of the alginate by chelation with multivalent ions is not easily controllable, so that the final mechanical properties of the product can vary in an unpredictable way. Furthermore, the gelled material can change its properties over time, due to the gradual release of the multivalent ions which therefore reduces the gelling degree.

### SUMMARY

The Applicant has now found that this problem, and others that will be better illustrated below, can be solved by means of a breakable flavouring capsule comprising: (a) at least one core comprising at least one flavouring agent dissolved or dispersed in at least one lipophilic substance; and (b) at least one breakable coating which coats said core and which comprises at least one chitosan having a selected average molecular weight.

In a first aspect, the present disclosure therefore relates to a smoking device comprising a tubular element containing tobacco and a filtering element connected to an end of said tubular element, wherein said filtering element includes at least one breakable flavouring capsule which comprises:

at least one core comprising at least one lipophilic substance and at least one flavouring agent dispersed or dissolved in said lipophilic substance;

at least one breakable coating which coats said core and which comprises at least one chitosan having a weight average molecular weight (Mw) comprised between 25 kDa and 400 kDa.

A second aspect of the present disclosure relates to a breakable flavouring capsule which comprises:

at least one core comprising at least one lipophilic substance and at least one flavouring agent dispersed or dissolved in said lipophilic substance;

at least one breakable coating which coats said core and which comprises at least one chitosan having a weight average molecular weight (Mw) comprised between 25 kDa and 400 kDa.

A third aspect of the present disclosure relates to the use of a capsule as defined above for flavouring the smoke generated in a smoking device. Preferably, said use includes crushing a filtering element of the smoking device which includes at least one capsule, so as to cause the capsule to break.

In the context of the present description and the accompanying claims, “breakable flavouring capsule” means a capsule which is able to convey a particular smell and/or taste to the smoke in transit through the filtering element, and which is able to shatter, that is to break, following the application of a crushing force exerted on said capsule, said force being preferably lower than 20 N.

Preferably the weight average molecular weight (Mw) of the chitosan is comprised between 50 kDa and 350 kDa.

Preferably, the chitosan is an at least partially depolymerized chitosan.

Preferably, the chitosan has a Brookfield viscosity, measured at 25° C. on an aqueous solution at 1% by weight of acetic acid containing 1% by weight of chitosan, from 20 to 300 cP.

The chitosan is a well-known derivative of chitin, obtainable by partial or total N-deacetylation of the same. Structurally, the chitosan is a copolymer of D-glucosamine and N-acetyl-D-glucosamine, linked by β-1,4-glycosidic bonds, having an average molecular weight higher than 1 mDa and corresponding to a chain of about 5000 monomeric units. However, the chitosan is insoluble in water and, in a dilute acid medium, gives rise to very viscous solutions. To increase the solubility of the chitosan and reduce the viscosity of the solutions obtained, the native chitosan is generally depolymerized (by chemical or enzymatic way) so as to reduce the molecular weight of the polymer. Among said depolymerization products, the ones preferred, for the purposes of the present disclosure, are those having a low molecular weight (LMW) and a median molecular weight (MMW), respectively comprised between about 50 kDa and 190 kDa and between about 190 kDa and 310 kDa.

The weight average molecular weight of chitosan can be determined according to known techniques, in particular by means of GPC analysis (Gel Permeation Chromatography).

According to a preferred embodiment of the present disclosure, the lipophilic substance in which the flavouring agent is dissolved or dispersed is selected from: triglycerides, in particular medium-chain C₆-C₁₂ fatty acid triglycerides, such as caproic, caprylic, capric and lauric acid, or mixtures thereof; vegetable oils, such as olive oil, corn seed oil, sunflower seed oil, peanut oil, soybean oil, coconut oil, almond oil.

According to a preferred embodiment of the present disclosure, the flavouring agent is selected from: bergamot oil, eucalyptol oil, mint oil, ethyl methylphenylglycidate (strawberry flavour), or mixtures thereof.

Preferably the core comprises: from 80% by weight to 99.5% by weight, more preferably from 90% by weight to 98% by weight, of at least one lipophilic substance, and from 0.5% by weight to 20% by weight, more preferably from 2% by weight to 10% by weight, of at least one flavouring agent, the percentage by weight being expressed with respect to the overall weight of the core.

Preferably, the capsules according to the present disclosure have a substantially spherical or ovoid shape.

According to a preferred embodiment of the present disclosure, the breakable coating further comprises at least one polyhydroxyalkanoate (PHA). Preferably, the breakable coating comprises: from 20% by weight to 80% by weight, more preferably from 30% by weight to 70% by weight, of at least one chitosan, and from 20% by weight to 80% by weight, more preferably from 30% by weight to 70% by weight, of at least one PHA, the percentage by weight being expressed with respect to the overall weight of the coating.

The use of chitosan mixed with a PHA allows to improve the workability compared to the chitosan alone, which is per se rather rigid and not easily processable. Furthermore, the addition of PHA to the chitosan makes the capsules more resistant to mechanical stress and therefore less subject to premature breakages during their introduction into the filtering element. Nevertheless, the capsules preserve the desired breakability property, i.e. they can still be broken by the user by simply crushing the filtering element with the fingers.

According to another preferred embodiment, the flavouring agent present in the core is adsorbed on PHA particles, which act as a carrier of the agent itself and allow higher quantities to be used thanks to the adsorbing capacity of the PHA particles, which are characterized by high porosity.

As is known, polyhydroxyalkanoates (PHAs) are organic polymers produced by microorganisms isolated from natural environments or even by genetically modified microorganisms, and are characterized by high biodegradability and biocompatibility.

They are produced and accumulated by various species of bacteria under unfavourable growth conditions and in the presence of a source of excess carbon. PHAs are synthesized and accumulated by about 300 different microbial species, included in more than 90 kinds of Gram-positive and Gram-negative bacteria, such as for example Bacillus, Rhodococcus, Rhodospirillum, Pseudomonas, Alcaligenes, Azotobacter, Rhizobium.

In bacterial cells, PHA is stored in form of microgranules, whose size and number per bacterial cell varies in different species. They appear as refractive inclusions under an electron microscope, with a diameter ranging from 0.2 to 0.7 μm.

Preferably, the PHA is a polymer containing repeating units of formula (I):

—O—CHR₁—(CH₂)ₙ—CO— (I)

where:
R₁ is chosen among: alkyls C₁-C₁₂, cycloalkyls C₄-C₁₆, alkenyls C₂-C₁₂, optionally substituted with at least one group chosen from: halogen (F, Cl, Br), —CN, —OH, —OOH, —OR, —COOR (R=C₁-C₄ alkyl, benzyl);
n is zero or an integer from 1 to 6, preferably 1 or 2.

Preferably, R₁ is methyl or ethyl, and n is 1 or 2.

The PHAs can either be homopolymers, copolymers or terpolymers. In the case of copolymers or terpolymers, they can include different repeating units of formula (I), or of at least one repeating unit of formula (I) in combination with at least one repeating unit deriving from comonomers that are able to copolymerize with hydroxyalkanoates, such as lactones or lactams. In the latter case, the repeating units of formula (I) are present in an amount equal to at least 10% in moles with respect to the total number of repeating units.

Particularly preferred repeating units of formula (I) are those deriving from: 3-hydroxybutyrate, 3-hydroxyvalerate, 3-hydroxyhexanate, 3-hydroxyoctanoate, 3-hydroxyundec-10-enoate, 4-hydroxyvalerate.

Particularly preferred PHAs are: polyhydroxybutyrate (PHB), poly-3-hydroxyvalerate (PHV), poly-3-hydroxyhexanate (PHH), poly-3-hydroxyoctanoate (PHO), poly(3-hydroxybutyrate-co-3-hydroxyvalerate) (PHBV), poly(3-hydroxybutyrate-co-3-hydroxyhexanoate) (PHBH), poly(3-hydroxybutyrate-co-4-hydroxybutyrate), poly(3-hydroxyoctanoate-co-3-hydroxyundecen-10-enoate) (PHOU), poly(3-hydroxybutyrate-co-3-hydroxyvalerate-4-hydroxyvalerate) (PHBVV), polyhydroxybutyrate-hydroxyvalerate copolymer, or mixtures thereof.

According to the purposes of the present disclosure, a particularly preferred PHA is polyhydroxybutyrate (PHB).

PHAs suitable for the present disclosure preferably have a weight average molecular weight (Mw) ranging from 5,000 Da to 1,500,000 Da, more preferably from 100,000 Da to 1,000,000 Da. The weight average molecular weight can be determined according to known techniques, in particular by means of GPC analysis (Gel Permeation Chromatography).

With regard to the production of PHAs, it is preferably obtained from the microbial fermentation of an organic substrate (for example carbohydrates or other fermentable substrates, such as glycerol) using a strain of microorganisms capable of producing PHAs, and the subsequent recovery of the PHAs from the cell mass.

For further details, reference can be made, for example, to patent applications WO 99/23146, WO 2011/045625 and WO 2015/015395. Suitable substrates for the production of PHAs by fermentation can be obtained in particular from the processing of plants, for example juices, molasses, pulps from the processing of sugar beet, sugar cane.

These substrates generally contain, in addition to sucrose and other carbohydrates, organic growth factors, nitrogen, phosphorus and/or other minerals which are useful as nutrients for cell growth.

According to the purposes of the present disclosure, the breakable coating preferably has a crushing strength comprised between 2 N and 16 N.

The crushing strength can be measured by means of a crushing test selected from those known in the art. An example of a crushing test includes positioning a capsule in the middle of a plate at a punch placed orthogonally. The punch moves gradually, approaching the capsule, usually at a speed of 1 mm/min. The motion of the punch continues even after touching the capsule and stops when the force exerted by the punch causes the capsule to break. From the moment in which the punch touches the capsule, until the latter breaks, the variation of the crushing force of the punch with respect to the resistance force exerted by the capsule is recorded. When the capsule breaks, the maximum crushing force exerted by the punch, needed overcome the resistance force of the capsule and cause the latter to break, is recorded. This value is measured in Newtons. Further details of this measurement method are reported for example in WO 2006/136197.

Preferably, the capsule according to the present disclosure has an average external diameter comprised between 0.5 mm and 10 mm, preferably between 1 mm and 6 mm.

Preferably, the breakable coating of the capsule according to the present disclosure has an average thickness comprised between 10 μm and 500 μm, more preferably between 30 μm and 200 μm.

As far as the filtering element is concerned, this can be made according to the known art, for example by compacting cellulose acetate fibres impregnated with a binding agent, usually triacetin or other binding products. Said fibres are compacted so as to form an elongated element, of substantially circular section, which is then cut to size to form the filtering element of the desired length.

### DETAILED DESCRIPTION OF THE DRAWINGS

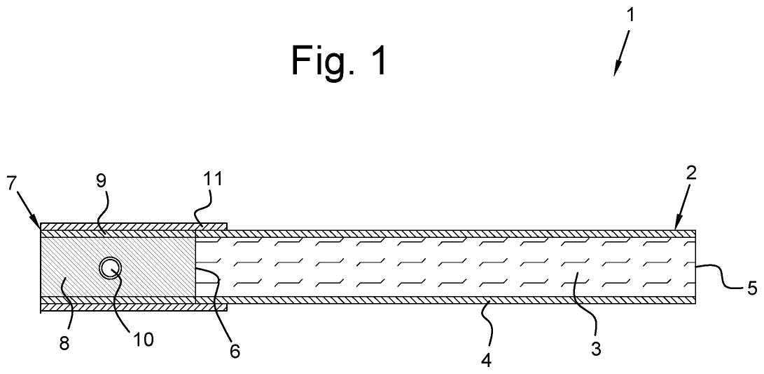

FIG. 1 represents, in longitudinal section, a possible embodiment of a smoking device, in particular a cigarette, in accordance with the present disclosure. The smoking device (1) comprises a tubular element (2), substantially cylindrical in shape, which contains tobacco (3). The tobacco (3) is wrapped in a layer of material (4), generally paper, which maintains the shape and dimensional stability of the tubular element (2).

The tubular element (2) comprises a first free end (5) intended to be lighted by the user, while the opposite end (6) is associated with a filtering element (7). The filtering element (7) is preferably in direct contact with the tobacco (3) contained in the tubular element (2) and axially aligned with the latter. Also the filtering element (7) has a substantially cylindrical shape, and includes a filtering material (8) (generally cellulose acetate fibres impregnated with triacetin) coated with a containment layer (9), generally formed by paper. Inside the filtering material (8) there is at least one capsule (10) in accordance with the present disclosure. The filtering element (7) generally also includes an outer layer (11) formed by substantially impermeable paper, which is intended to come into contact with the user's fingers and which also acts as a connecting element between the tubular element (2) and the filtering element (7).

The capsule, according to the present disclosure, is preferably obtained by a coextrusion process through

a coaxial needle.

More in detail, the capsule according to the present disclosure is preferably prepared by a process which comprises the steps of:

providing a suspension or a solution of at least one flavouring agent in at least one lipophilic substance;

providing a solution or an aqueous acid suspension of at least one chitosan;

coextruding said suspension or solution of at least one flavouring agent and said solution or acid aqueous suspension of at least one chitosan through a coaxial needle, so as to coat cores of said suspension or solution of at least one flavouring agent with a coating layer of said solution or acid aqueous suspension of at least one chitosan;

solidifying and drying said cores thus coated by obtaining the capsules.

Coextrusion through coaxial needle is a process known to those skilled in the art. It is a process of synchronous extrusion of two liquids: an external liquid phase, usually hydrophilic, and an internal liquid phase, usually lipophilic. Said process basically includes three steps: formation of a drop, at the tip of the coaxial needle, comprising the two liquid phases arranged coaxially; collection of the drop; solidification of the outermost liquid phase; collection of the capsule thus formed. Preferably, the capsules are produced by means of a device and a process as described in EP 0 513 603.

Preferably, the step of solidifying the capsule obtained from the coextrusion step through coaxial needle is preferably carried out by immersing the just coextruded capsule into a solidification solution. The solidification solution is preferably an aqueous solution of a product selected from: alkali or alkaline-earth metal hydroxides (in particular NaOH or KOH), sodium pentabasic triphosphate, phytic acid, sodium citrate, oxalic acid, or mixtures thereof. The immersion is generally carried out at room temperature for a time comprised between 10 minutes and 10 hours.

The step of drying the coextruded and solidified capsule preferably provides for heating for a time comprised between 1 hour and 10 hours at a temperature between 30° C. and 70° C.

The following examples of embodiment are provided for the sole purpose of illustrating the present disclosure and are not to be understood in a sense limiting the scope of protection defined by the appended claims.

### EXAMPLE 1

An acid aqueous solution (1% w/w acetic acid) of a mixture of two chitosans of different molecular weight, i.e. a median molecular weight chitosan (Mw=about 200 kDa, concentration=3% w/w) and a low molecular weight chitosan (Mw=about 80 kDa, concentration=1% w/w), was prepared.

The solution was kept at 40° C. and mixed until complete dissolution of the two chitosans.

A suspension of PHB particles, on which bergamot oil was adsorbed, in a caprylic/capric triglyceride (PHB 10% w/w, bergamot oil 3% w/w) was prepared.

The solution and the suspension were coextruded through coaxial needle; the drops formed by coextrusion were collected inside a 1M NaOH solution, left in immersion for 3 hours, transferred to a 1% sodium pentabasic triphosphate solution (cross-linking solution) and left in immersion throughout the night. Subsequently the capsules were washed with water and dried at 50° C. for 5 hours.

### EXAMPLE 2

An acid aqueous solution (3% w/w acetic acid) of chitosan (low molecular weight chitosan Mw=about 80 kDa, concentration=5% w/w) was prepared. The solution was kept at 40° C. and mixed until complete dissolution of the chitosan

A suspension of PHB particles, on which eucalyptol oil was adsorbed, in a caprylic/capric triglyceride (PHB 10% w/w, eucalyptol oil 3% w/w) was prepared.

The solution and the suspension were coextruded through coaxial needle; the drops formed by coextrusion were collected inside a 1M NaOH solution, left in immersion for 3 hours, transferred to a 1% sodium pentabasic triphosphate solution (cross-linking solution) and left in immersion throughout the night. Subsequently the capsules were washed with water and dried at 50° C. for 5 hours.

### EXAMPLE 3

An acid aqueous solution (1% w/w acetic acid) of chitosan (median molecular weight chitosan Mw=about 200 kDa, concentration=3.5% w/w) was prepared. The solution was kept at 40° C. and mixed until complete dissolution of the chitosan

A suspension of PHB particles, on which eucalyptol oil was adsorbed, in a caprylic/capric triglyceride (PHB 10% w/w, eucalyptol oil 3% w/w) was prepared.

The solution and the suspension were coextruded through coaxial needle; the drops formed by coextrusion were collected inside a 1M NaOH solution, left in immersion for 3 hours, transferred to a 1% sodium pentabasic triphosphate solution (cross-linking solution) and left in immersion throughout the night. Subsequently the capsules were washed with water and dried at 50° C. for 5 hours.

### EXAMPLE 4

### Crushing Test

The crushing resistance of the capsules of Examples from 1 to 3 was measured using the Zwick Roell's tool “cLine materials testing machine Z010” with specific configuration for crushing tests.

The measurements were performed by positioning one capsule at a time in the middle of the tool plate, at the punch. The movement speed of the punch has been set at 1 mm/min.

At the moment of the breakage of each capsule, the maximum crushing force exerted by the punch, needed to overcome the resistance force of the capsule and cause the latter to break, was recorded. This value was measured in Newtons (N). For each type of capsule the test was repeated 20 times and the values reported in Table 1 represent the average value.

Following the protocol described above, three different tests were performed:

measurement of the initial crushing strength, i.e. on the capsule as it is;

measurement of the crushing strength of the capsule after having subjected it, for 5 minutes, to a temperature of 40° C. and a humidity percentage of 90%;

measurement of the crushing strength of the capsule after having subjected it, for 4 hours, to a temperature of 40° C. and a humidity percentage of 90%.

TABLE 1

| | Initial | Crushing | Crushing |
|---|---|---|---|
| | crushing | strength (N) | strength (N) |
| | strength | (5 min, 40° C., | (4 h, 40° C., |
| Sample | (N) | 90% UR) | 90% UR) |
| Capsule (Ex. 1) | 8.55 | 9.95 | 11.20 |
| Capsule (Ex. 2) | 6.77 | 8.62 | 8.58 |
| Capsule (Ex. 3) | 7.76 | 9.10 | 10.23 |

### EXAMPLE 5

An acid aqueous solution (1% w/w acetic acid) of chitosan (median molecular weight chitosan Mw=about 80 kDa, concentration=1.75% w/w) was prepared. The solution was kept at 40° C. and mixed until complete dissolution of the chitosan PHB in particle form (PHB concentration 3% w/w) was added and the mixture was emulsified.

A solution of eucalyptol oil in caprylic/capric triglyceride (9% w/w eucalyptol oil) was prepared.

A coextrusion of the emulsion and the solution was carried out through coaxial needle; the drops formed by coextrusion were collected in a 1M NaOH solution, left in immersion for 30 minutes, transferred to a 1% sodium pentabasic triphosphate solution (cross-linking solution) and left in immersion throughout the night. Subsequently the capsules were washed with water and dried at 50° C. for 5 hours.

### EXAMPLE 6

An acid aqueous solution (3% w/w acetic acid) of chitosan (low molecular weight chitosan Mw=about 80 kDa, concentration=5% w/w) was prepared. The solution was kept at 40° C. and mixed until complete dissolution of the chitosan PHB in particle form (PHB concentration 5% w/w) was added and the mixture was emulsified.

A solution of eucalyptol oil in caprylic/capric triglyceride (9% w/w eucalyptol oil) was prepared.

A coextrusion of the emulsion and the solution was carried out through coaxial needle; the drops formed by coextrusion were collected in a 1M NaOH solution, left in immersion for 30 minutes, transferred to a 1% sodium pentabasic triphosphate solution (cross-linking solution) and left in immersion throughout the night. Subsequently the capsules were washed with water and dried at 50° C. for 5 hours.

### EXAMPLE 7

An acid aqueous solution (1.5% w/w acetic acid) of chitosan (median molecular weight chitosan Mw=about 200 kDa, concentration=2.5% w/w) was prepared. The solution was kept at 40° C. and mixed until complete dissolution of the chitosan PHB in particle form (PHB concentration 2.5% w/w) was added and the mixture was emulsified.

A solution of eucalyptol oil in caprylic/capric triglyceride (9% w/w eucalyptol oil) was prepared.

A coextrusion of the emulsion and the solution was carried out through coaxial needle; the drops formed by coextrusion were collected in a 1M NaOH solution, left in immersion for 30 minutes, transferred to a 1% sodium pentabasic triphosphate solution (cross-linking solution) and left in immersion throughout the night. Subsequently the capsules were washed with water and dried at 50° C. for 5 hours.

### EXAMPLE 8

### Crushing Test

The crushing resistance of the capsules of Examples 5 to 7 was measured as described in Example 4. The results are reported in Table 2.

TABLE 2

| | Initial | Crushing | Crushing |
|---|---|---|---|
| | crushing | strength (N) | strength (N) |
| | strength | (5 min, 40° C., | (4 h, 40° C., |
| Sample | (N) | 90% UR) | 90% UR) |
| Capsule (Ex. 5) | 5.44 | 6.83 | 7.27 |
| Capsule (Ex. 6) | 8.05 | 8.48 | 9.60 |
| Capsule (Ex. 7) | 4.00 | 7.90 | 8.05 |

From the results reported in Tables 1 and 2 it is evident that the capsules according to the present disclosure possess a breakable coating capable of preserving its hardness, and therefore its breakability, even in the presence of humidity and heat. This is also demonstrated under particularly severe conditions, i.e. after a 4-hour treatment at a temperature of 40° C. and a humidity of 90%.

1. A smoking device comprising a tubular element containing tobacco and a filtering element connected to an end of said tubular element, wherein said filtering element includes at least one breakable flavouring capsule which comprises:
at least one core comprising at least one lipophilic substance and at least one flavouring agent dispersed or dissolved in said lipophilic substance; and
at least one breakable coating which coats said core and which comprises at least one chitosan having a weight average molecular weight (Mw) comprised between 25 kDa and 400 kDa.

2. The device according to claim 1, wherein said at least one chitosan has a weight average molecular weight (Mw) comprised between 50 kDa and 350 kDa.

3. The device according to claim 1, wherein said at least one chitosan has a Brookfield viscosity, measured at 25° C. on an aqueous solution at 1% by weight of acetic acid containing 1% by weight of chitosan, from 20 to 300 cP.

4. The device according to claim 1, wherein said at least one lipophilic substance is selected from the group consisting of: triglycerides, in particular medium-chain C₆-C₁₂ fatty acid triglycerides, such as caproic, caprylic, capric and lauric acid, or mixtures thereof; vegetable oils, such as olive oil, corn seed oil, sunflower seed oil, peanut oil, soybean oil, coconut oil, almond oil.

5. The device according to claim 1, wherein said at least one flavouring agent is selected from the group consisting of: bergamot oil, eucalyptol oil, mint oil, ethyl methylphenylglycidate (strawberry flavour), or mixtures thereof.

6. The device according to claim 1, wherein the core comprises: from 80% by weight to 99.5% by weight of at least one lipophilic substance, and from 0.5% by weight to 20% by weight of at least one flavouring agent, the percentage by weight being expressed with respect to the overall weight of the core.

7. The device according to claim 1, wherein the breakable coating further comprises at least one polyhydroxyalkanoate (PHA).

8. The device according to claim 7, wherein the breakable coating comprises: from 20% by weight to 80% by weight of at least one chitosan, and from 20% by weight to 80% by weight of at least one PHA, the percentage by weight being expressed with respect to the overall weight of the coating.

9. The device according to claim 1, wherein said at least one flavouring agent is adsorbed on particles of a PHA.

10. The device according to claim 7, wherein the PHA is selected from the group consisting of: poly-hydroxybutyrate (PHB), poly-3-hydroxyvalerate (PHV), poly-3-hydroxyhexanoate (PHH), poly-3-hydroxyoctanoate (PHO), poly(3-hydroxybutyrate-co-3-hydroxyvalerate) (PHBV), poly(3-hydroxybutyrate-co-3-hydroxyesanoate) (PHBH), poly(3-hydroxybutyrate-co-4-hydroxybutyrate), poly(3-hydroxyoctanoate-co-3-hydroxyundecen-10-enoate) (PHOU), poly(3-hydroxybutyrate-co-3-hydroxyvalerate-co-4-hydroxyvalerate) (PHBVV), polyhydroxybutyrate-hydroxyvalerate copolymer, or mixtures thereof.

11. The device according to claim 1, wherein said at least one breakable coating has a crushing strength comprised between 2 N and 16 N.

12. A breakable flavouring capsule which comprises:
at least one core comprising at least one lipophilic substance and at least one flavouring agent dispersed or dissolved in said lipophilic substance; and
at least one breakable coating which coats said core and which comprises at least one chitosan having a weight average molecular weight (Mw) comprised between 25 kDa and 400 kDa.

13. The capsule according to claim 12 and further comprising:
at least one core comprising at least one lipophilic substance and at least one flavouring agent dispersed or dissolved in said lipophilic substance;
at least one breakable coating which coats said core and which comprises at least one chitosan having a weight average molecular weight (Mw) comprised between 50 kDa and 350 kDa.

14. Use of a capsule according to claim 12, to aromatize the smoke generated in a smoking device.

15. A process for producing a capsule according to claim 12, the process including the following steps:
providing a suspension or a solution of at least one flavouring agent in at least one lipophilic substance,
providing a solution or an aqueous acid suspension of at least one chitosan,
coextruding said suspension or solution of at least one flavouring agent and said solution or acid aqueous suspension of at least one chitosan through a coaxial needle, so as to coat cores of said suspension or solution of at least one flavouring agent with a coating layer of said solution or acid aqueous suspension of at least one chitosan, and
solidifying and drying said cores thus coated by obtaining the capsules.

16. The process according to claim 15, wherein the step of solidifying the coated cores is carried out by immersing the capsule as soon as coextruded in a solidification solution.

17. The process according to claim 16, wherein the solidification solution is an aqueous solution of a product selected from the group consisting of: alkali or alkaline-earth metal hydroxides (in particular NaOH or KOH), sodium pentabasic triphosphate, phytic acid, sodium citrate, oxalic acid, or mixtures thereof.
